(19) United States
(12) Patent Application Publication
(10) Pub. No.: US 2013/0173447 A1
(43) Pub. Date: Jul. 4, 2013

(54) CONSUMER-DRIVEN CREDIT INFORMATION CONTROL METHOD, SYSTEM AND STORAGE MEDIUM FOR STORING A SET OF COMPUTER INSTRUCTIONS WHICH EFFECTUATE THE METHOD

(71) Applicant: Walter J. Rothschild, Bloomfield Village, MI (US)

(72) Inventor: Walter J. Rothschild, Bloomfield Village, MI (US)

(21) Appl. No.: 13/340,823

(22) Filed: Dec. 30, 2011

(51) Int. Cl. G06Q 40/02

(52) U.S. Cl. 705/38

(57) ABSTRACT

A consumer-driven credit information control method, system and storage medium for storing a set of computer instructions which effectuate the method are provided. The method includes the step of receiving a selection signal from a consumer to at least partially establish a relationship between the consumer and a credit reporting agency (CRA) or agent entity. The method further includes receiving personal data including credit data of the consumer such as from either the consumer or the CRA, and storing the personal data in a database of the CRA or agent entity. The method still further includes receiving a data request signal from the consumer, transmitting at least a portion of accessed personal data from the CRA or agent entity to the consumer based on the data request signal, and receiving an authorization signal from the consumer.

### BACKGROUND OF THE INVENTION

1. Field of the Invention

This invention relates to consumer-driven credit information control methods, systems and storage media for storing sets of computer instructions which effectuate the methods.

2. Background Art

FIGS. 1-3 illustrate the current model by which consumers interact with credit reporting agencies (CRAs) and lenders. As illustrated in FIG. 1, various lenders (and intermediaries) spend money marketing (via various communication channels) to consumers in order to attract consumers who either are ready to apply for credit or are considering applying for credit.

FIG. 2 illustrates consumers selecting a lender and subsequently applying for credit. The selected lender obtains credit files from one or more CRAs for decision and, if a loan is approved, reports a new credit line (i.e. trade line) to the CRAs.

FIG. 3 illustrates a lender reporting consumer payment behavior to CRAs.

The Nathans et al. U.S. Pat. No. 7,139,734 describes a credit information data collection method and a repository management system. Credit data as maintained in the repository is used to report a credit score, which occurs only when the consumer authorizes the release of the data. User terminals allow users to authorize release of their credit data to residential housing credit providers and allow consumers to obtain copies of their records from the repository.

U.S. patent application to Wilshinsky et al. 2006/0111991 describes a confidential information sharing system. A confidential data consumer unit, such as a loan underwriter or other credit granting agency, requests confidential data relative to a specific individual entity from a data sharing interface, after receiving authorization from the individual entity. Preferably, the individual entity authorization includes a machine-readable identification, such as a driver's license, which is also transmitted to the data sharing interface. In addition, the confidential data consumer unit also transmits identification information, by providing a machine-readable identification to the data sharing interface along with the data request to be processed.

U.S. patent application publication to Holland 2006/0204051 describes a method and system for managing account information. When a creditor or other party desires to update a subscriber's credit file at a credit bureau, the creditor or other party makes a request to a credit bureau. The credit bureau notifies a trusted third party of the request and, in turn, the trusted third party authenticates the subscriber and obtains the subscriber's approval for the update. The trusted third party notifies the credit bureau of the approval whereupon the credit bureau updates the credit file or account as requested by the creditor or other third party.

U.S. patent application publication to Zimmerman 2007/0156553 describes a credit proxy system and method. The system and method provide to a consumer or other debtor protection against use of the debtor's identity to establish credit using an intermediary that is adapted to communicate with both the debtor and a potential credit grantor. There is a registration process in which the debtor registers with the intermediary; the registration includes user identification information and a level of protection that is authorized by the debtor on new credit. The consumer may choose Level 4 protection that requires that each creditor be specifically authorized by the consumer on a credit proxy website before credit is extended.

U.S. patent application publication to Metzger et al. 2008/0294689 describes a credit report locking/unlocking via telephone interface. A voice-based credit report access system is operative to accept telephone requests to lock or unlock a credit report and pass those requests to a credit report retrieval system. When the request is received, the credit report retrieval system accordingly updates the consumer's entry in a lock status database. When the credit report retrieval system receives a credit report request, the lock status database is queried. If the consumer's entry has a locked status, the credit report is denied. If the status is unlocked, the credit report is provided to the requestor.

The following U.S. patent documents are also related: U.S. Pat. No. 7,028,052; 2007/0083463 and 2008/0208726.

### SUMMARY OF THE INVENTION

An object of at least one embodiment of the present invention is to provide a consumer-driven credit information control method, system and storage medium for storing a set of computer instructions which effectuate the method, wherein individuals are provided the ability to establish an “account-like” relationship with a preferred CRA or a “non-CRA entity” to act as an “agent” (agent entity) of the consumer in interactions with CRAs. The method and system provide for proactive and willing submission of personal credit and other indicative information by consumers and readily accessible tools and services for consumers to control the distribution and use of their personal file.

Another object of at least one embodiment of the present invention is to provide a consumer-driven credit information control method, system and storage medium for storing a set of computer instructions which effectuate the method, wherein consumers have comprehensive access, control and knowledge regarding the compilation, use and distribution of their personal credit information.

In carrying out the above objects and other objects of at least one embodiment of the present invention, a consumer-driven, credit information control method is provided. The method includes the steps of receiving a selection signal from a consumer to at least partially establish a relationship between the consumer and a credit reporting agency or agent entity, receiving personal data including credit data of the consumer, and storing the personal data in a database of the credit reporting agency or agent entity. The method further includes receiving a data request signal from the consumer which represents a request by the consumer to access the personal data from the database, transmitting at least a portion of the accessed personal data from the credit reporting agency or the agent entity to the consumer based on the data request signal, and receiving additional data from the consumer which represents proposed additions or deletions to the accessed personal data. The method still further includes receiving a data forward request signal from the consumer which represents a request by the consumer to forward the additional data to a preferred credit reporting agency or any credit reporting agency, transmitting the additional data based on the data forward request signal, receiving a first authorization signal from the consumer which represents authorization for the credit reporting agency or agent entity to request an offer of credit from a lender, and receiving a second authorization signal from the consumer which represents authorization for the credit reporting agency or agent entity to include the personal data of the consumer in the request of the credit reporting agency or agent entity.

The method may further include transmitting an offer request signal from the credit reporting agency or agent entity to the lender requesting an offer of credit from the lender based on the first authorization signal.

The method may further include transmitting market standing data from the credit reporting agency or agent entity to the consumer.

The method may further include receiving personal and credit line data from at least one of the consumer and the lender and storing the credit line data in the database.

The method may further include receiving payment record data from the lender, the record data representing a record of the consumer payments on a loan received by the consumer from the lender.

Further in carrying out the above objects and other objects of at least one embodiment of the present invention, a consumer-driven, credit information control system is provided. The system includes means for receiving a selection signal from a consumer of credit to at least partially establish a relationship between the consumer and a credit reporting agency, means for receiving personal data including credit data of the consumer, and a database of the credit reporting agency or agent entity for storing the personal data. The system further includes means for receiving a data request signal from the consumer which represents a request by the consumer to access the personal data from the database, means for transmitting at least a portion of the accessed personal data from the credit reporting agency or agent entity to the consumer based on the data request signal, and means for receiving additional data from the consumer which represents proposed additions or deletions to the accessed personal data. The system still further includes means for receiving a data forward request signal from the consumer which represents a request by the consumer to forward the additional data to a preferred credit reporting agency or any credit reporting agency, means for transmitting the additional data based on the data forward request signal, means for receiving a first authorization signal from the consumer which represents authorization for the credit reporting agency or agent entity to request an offer of credit from a lender, and means for receiving a second authorization signal from the consumer which represents authorization for the credit reporting agency or agent entity to include the personal data of the consumer in the request of the credit reporting agency or agent entity.

The system may further include means for transmitting an offer request signal from the credit reporting agency or agent entity to the lender requesting an offer of credit from the lender based on the first authorization signal.

The system may further include means for transmitting market standing data from the credit reporting agency or agent entity to the consumer.

The system may further include means for receiving personal and credit line data from at least one of the consumer and the lender, the database storing the credit line data.

The system may further include means for receiving payment record data from the lender, the record data representing a record of the consumer payments on a loan received by the consumer from the lender.

Yet still further in carrying out the above objects and other objects of at least one embodiment of the present invention, a computer readable non-transitory storage medium that stores a set of software instructions which, when executed, controls credit information is provided. The set of software instructions includes software instructions for receiving a selection signal from a consumer to at least partially establish a relationship between the consumer and a credit reporting agency or agent entity, receiving personal data including credit data of the consumer, and storing the personal data in a database of the credit reporting agency or agent entity. The set of software instructions further includes receiving a data request signal from the consumer which represents a request by the consumer to access the personal data from the database, transmitting at least a portion of the accessed personal data from the credit reporting agency or agent entity to the consumer based on the data request signal, and receiving additional data from the consumer which represents proposed additions or deletions to the accessed personal data. The set of software instructions still further includes receiving a data forward request signal from the consumer which represents a request by the consumer to forward the additional data to a preferred credit reporting agency or any credit reporting agency, transmitting the additional data based on the data forward request signal, receiving a first authorization signal from the consumer which represents authorization for the credit reporting agency or agent entity to request an offer of credit from a lender, and receiving a second authorization signal from the consumer which represents authorization to the credit reporting agency or agent entity to include the personal data of the consumer in the request of the credit reporting agency or agent entity.

The set of software instructions may further include software instructions for transmitting an offer request signal from the credit reporting agency to the lender requesting an offer of credit from the lender based on the first authorization signal.

The set of software instructions may further include software instructions for transmitting market standing data from the credit reporting agency or agent entity to the consumer.

The set of software instructions may include software instructions for receiving personal and credit line data from at least one of the consumer and the lender and for storing the credit line data in the database.

The set of software instructions may include software instructions for receiving payment record data from the lender, the record data representing a record of the consumer payments on a loan received by the consumer from the lender.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIGS. 1-3 are schematic drawings of a prior art credit information and reporting system, wherein lenders spend marketing money to attract consumers who are ready to apply (or are considering applying) for credit in FIG. 1; consumer selects lender and applies in FIG. 2; lender obtains credit files from CRAs for decision and reports new credit line to CRAs in FIG. 2; and lender reports consumer payment behavior to CRAs in FIG. 3; and

FIGS. 4a-4c are schematic diagrams of a consumer-driven credit information control and reporting method and system (i.e. “consumer driven 1”) constructed in accordance with at least one embodiment of the present invention; and

FIGS. 5a-5c are schematic diagrams of a consumer-driven credit information control and reporting method and system (i.e. “consumer driven 2”) constructed in accordance with another embodiment of the present invention.

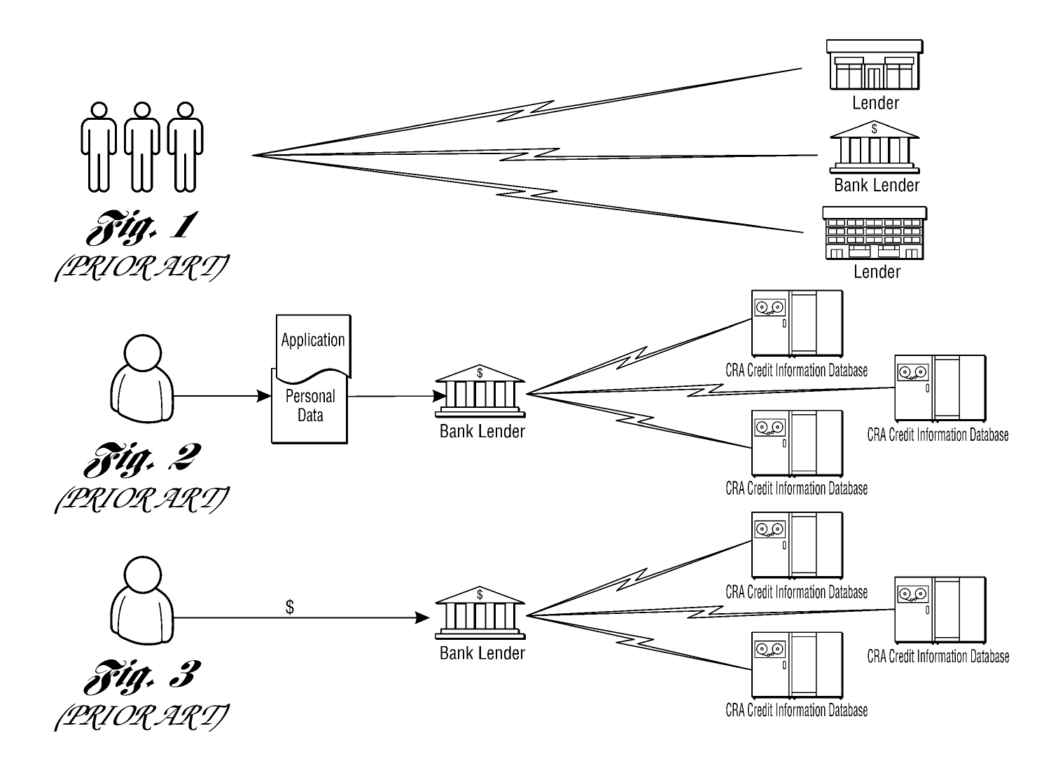

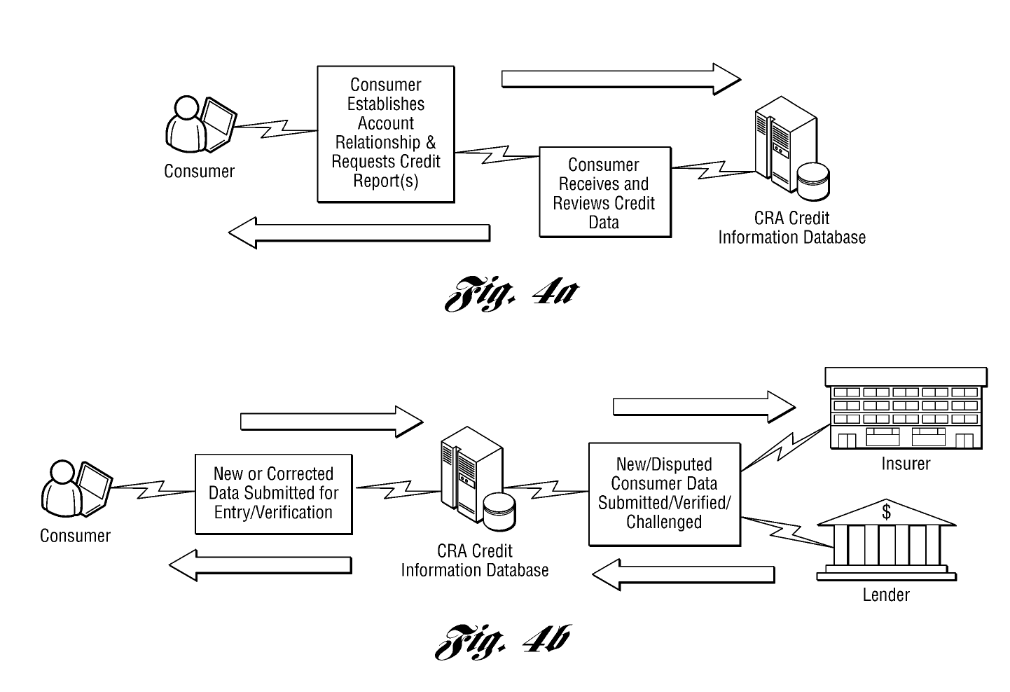

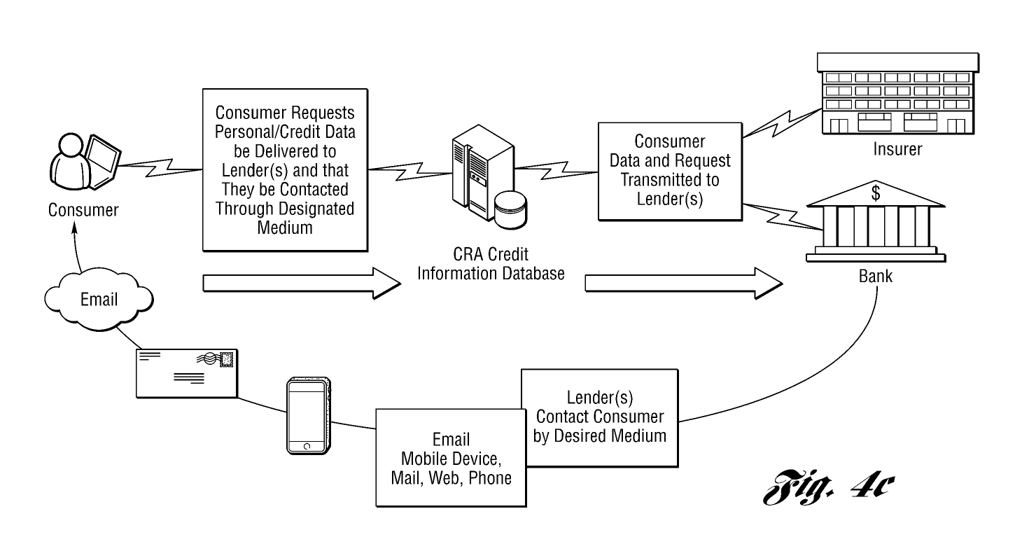

### DETAILED DESCRIPTION OF THE PREFERRED EMBODIMENT(S)

In general, at least one embodiment of the present invention pertains to the processes and method surrounding the collection, management, control and use of personal credit data (consumer credit information) in the United States. It is directed specifically toward solving the problem of the inherent inaccuracies in and the inefficiency in the access and control of credit files/reports that are currently available to consumers. At least one embodiment of the invention creates a new “open” or “consumer-driven” credit reporting model/system. This new method improves efficiency in the consumer credit markets by facilitating better access and control of credit files by individuals, yielding more accurate and timely data/information, more precise and rational risk management practices by lenders, improved understanding by consumers, and lower cost for access by consumers. It will also facilitate innovation and new tools to mitigate the risk of identity theft. For purposes of this application a “consumer” means an individual entity such as a human or non-human consumer or business. Also, for purposes of this application “personal data” includes data related to a consumer's credit rating such as bank loan transaction records, utility payment records, credit card payment records, name, address, employer, or any other data contributed by consumer.

For purposes of this application, an “offer of credit” may be an invitation to complete and submit an application. Alternatively, an “offer of credit” may be a firm commitment by a lender to extend a certain type and amount of credit based on prior information or application submitted.

Regarding the delivery of an “offer of credit” from a lender: an “offer of credit” may be delivered directly from the lender to the consumer through a channel (email, phone, text, mail, etc.) designated by the consumer. Alternatively, an “offer of credit” may be delivered to the consumer through the preferred credit reporting agency or agent entity as designated by the consumer as part of the “account-like” relationship.

At least one embodiment of the invention has a favorable impact on the application of existing and future laws and lawmaking activities aimed at consumer credit. The new method of at least one embodiment of the invention directly support the intent, objectives, and spirit of the Fair Credit Reporting Act (FCRA) (codified at 15 U.S.C. §1681 et seq.) and the Fair and Accurate Credit Transactions Act (FACTA, Pub. L. 108-159) aimed at credit reporting practices to ensure the fair treatment and rights of individual consumers.

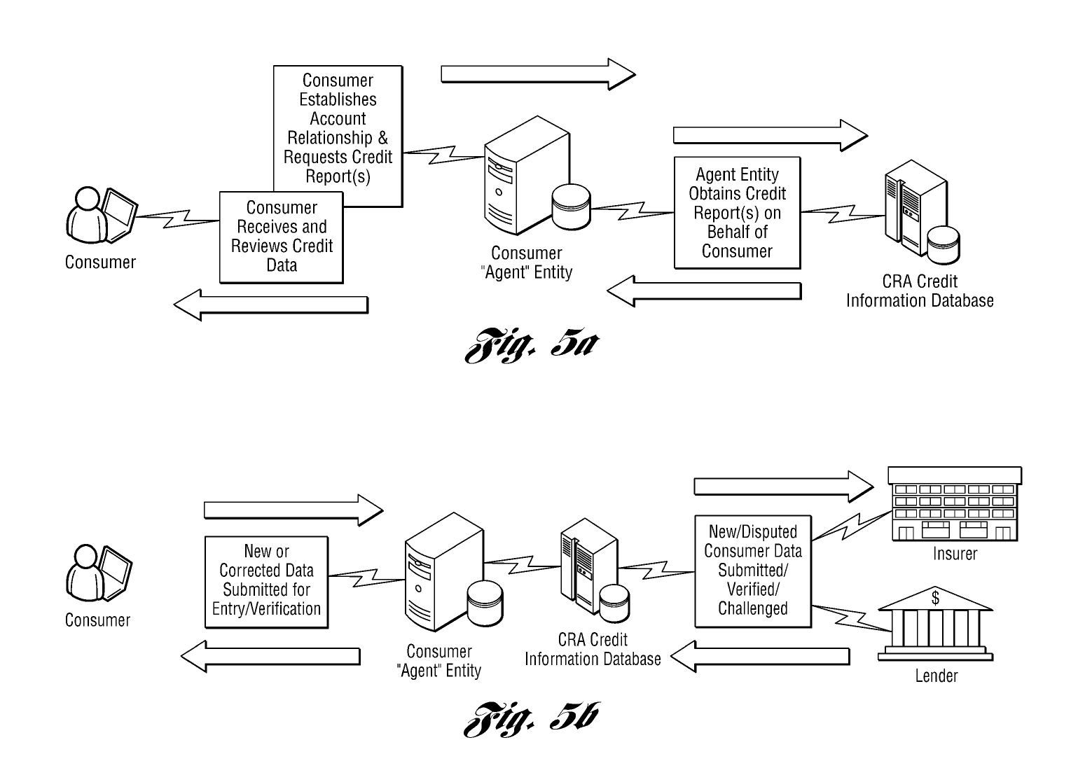

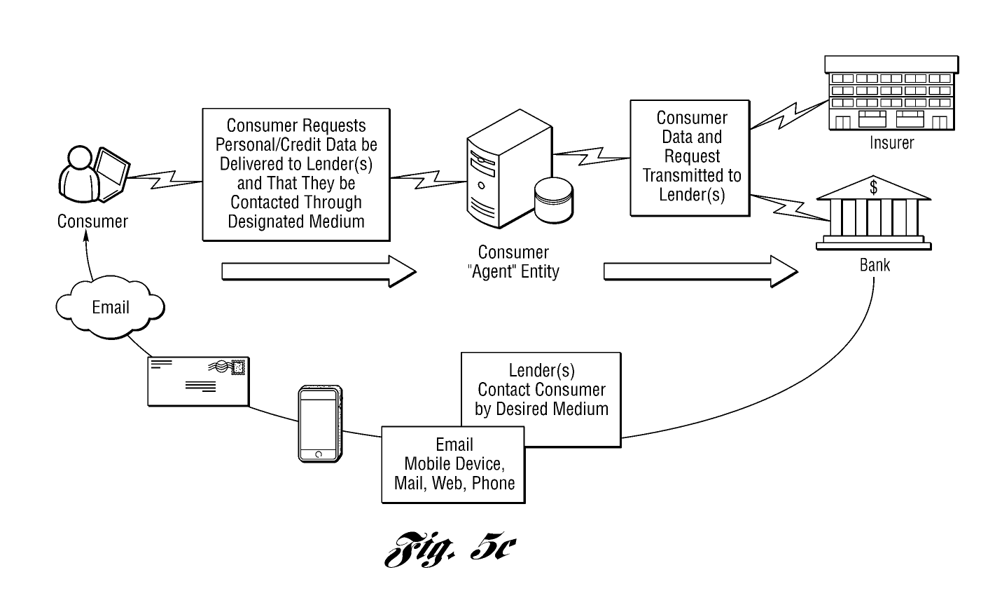

As illustrated in FIGS. 4a-4c and 5a-5c, at least one embodiment of the invention provides for the proactive and willing submission of personal data (indicative and credit) over a communication channel via a computer by consumers to a CRA (i.e. FIGS. 4a-4c) or agent entity (i.e. FIGS. 5a-5c) and providing readily accessible tools and services for consumers to control the distribution and use of their personal file by the CRA or agent entity. The CRA and lenders communicate and verify the credit data over a communication channel.

The consumer is considering or decides to apply for credit and obtains a credit report directly from the CRA (FIG. 4a) or agent entity (FIG. 5a) “account” via a computer over a communication channel.

An objective of at least one embodiment of the invention is to provide consumers comprehensive access, control and knowledge regarding the compilation, use and distribution of their personal credit information. At least one embodiment of the invention provides consumers the ability to direct the Credit Reporting Agency (CRA—FIG. 4c) or agent entity (FIG. 5c) via computer over a communication channel to initiate requests for offers of credit from lenders over a communication channel. In other words, the consumer authorizes the CRA or agent entity to notify lenders of the consumer's intent to apply for credit [and potentially also to provide the lenders with the consumer's personal credit information].

Subsequently, the consumer is contacted by any interested lender through a preferred communication channel of a network such as the Internet or other telecommunication network. Then, if a loan is executed pursuant to this interaction, the consumer and the lender report the new credit line to the CRA or agent entity (in the consumer's case) over communication channels. The lender reports the payment record of the consumer to the CRA during repayment of the loan over a communication channel.

At least one embodiment of the invention advances the objectives of the FCRA permissible purpose [15 U.S.C. §1681(b)] protections to a practical, market driven methodology by embracing the spirit of the FCRA and permissible purpose. Under this embodiment of the invention, consumers have easy, low cost transactional access to their files/“account” over a communication channel before they apply for credit. This will result in consumers gaining greater understanding of their credit product and pricing options leverage based on their current risk profile relative to the market at large and the detailed record of their credit history. The free flow of credit information to consumers will level the data imbalance in consumer credit transactions, similar to how the increased availability of manufacturer cost information has leveled the imbalance and empowered the consumer in automobile purchase transactions.

The flow of data and signals described above may be supported on one or more public and/or private communications networks such as the Internet or other telecommunication networks such as the telephone network. Channel refers to the physical or non-physical medium through which the signals propagate.

A computer interface of a computer (or other I/O device) may be provided to each consumer where each authorized consumer is able to transmit requests and signals and receive information or data over the communications network. Any network will do such as a computer network like the Internet. The requests are transmitted from the consumer's interface to a database server. A data mining engine at the server may receive requests to analyze the data in the database, analyzes the data and transmits the resulting analysis or report to the requestor over the communications network. Data and information is communicated to and from users through computer interfaces or other means. Each interface is typically provided by a computer program. Each interface may include text input forms and/or graphical elements.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A consumer-driven, credit information control method comprising the steps of:
receiving, by a computer, a selection signal from a consumer to at least partially establish a relationship between the consumer and a credit reporting agency or agent entity;
receiving personal data including credit data of the consumer, wherein the personal data includes at least one of bank loan transaction records, utility payment records, credit card payment records, name, address, employer, and the like that relate to a credit rating of the consumer;
storing the personal data in a database of the credit reporting agency or agent entity;
receiving, by the computer, a data request signal from the consumer which represents a request by the consumer to access the personal data from the database;
transmitting at least a portion of the accessed personal data from the credit reporting agency or the agent entity to the consumer based on the data request signal via the computer;
receiving, by the computer, additional personal data from the consumer which represents proposed additions or deletions to the accessed personal data;
receiving, by the computer, a data forward request signal from the consumer which represents a request by the consumer to forward the additional personal data to a preferred credit reporting agency or any credit reporting agency;
transmitting the additional personal data based on the data forward request signal;
receiving, by the computer, a first authorization signal from the consumer which represents authorization for the credit reporting agency or agent entity to request an offer of credit from a lender; and
receiving, by the computer, a second authorization signal from the consumer which represents authorization for the credit reporting agency or agent entity to include the personal data of the consumer in the request of the credit reporting agency or agent entity.

2. The method as claimed in claim 1 further comprising transmitting an offer request signal from the credit reporting agency or agent entity to the lender requesting an offer of credit from the lender based on the first authorization signal.

3. The method as claimed in claim 1 further comprising transmitting market standing data from the credit reporting agency or agent entity to the consumer.

4. The method as claimed in claim 1 further comprising receiving personal and credit line data from at least one of the consumer and the lender and storing the credit line data in the database.

5. The method as claimed in claim 4 further comprising receiving payment record data from the lender, the record data representing a record of the consumer payments on a loan received by the consumer from the lender.

6. A consumer-driven, credit information control system comprising:
means for receiving a selection signal from a consumer to at least partially establish a relationship between the consumer and a credit reporting agency;
means for receiving personal data including credit data of the consumer, wherein the personal data includes at least one of bank loan transaction records, utility payment records, credit card payment records, name, address, employer, and the like that relate to a credit rating of the consumer;
a database of the credit reporting agency or agent entity for storing the personal data;
means for receiving a data request signal from the consumer which represents a request by the consumer to access the personal data from the database;
means for transmitting at least a portion of the accessed personal data from the credit reporting agency or agent entity to the consumer based on the data request signal;
means for receiving additional personal data from the consumer which represents proposed additions or deletions to the accessed personal data;
means for receiving a data forward request signal from the consumer which represents a request by the consumer to forward the additional personal data to a preferred credit reporting agency or any credit reporting agency;
means for transmitting the additional personal data based on the data forward request signal;
means for receiving a first authorization signal from the consumer which represents authorization for the credit reporting agency or agent entity to request an offer of credit from a lender; and
means for receiving a second authorization signal from the consumer which represents authorization for the credit reporting agency or agent entity to include the personal data of the consumer in the request of the credit reporting agency or agent entity.

7. The system as claimed in claim 6 further comprising means for transmitting an offer request signal from the credit reporting agency or agent entity to the lender requesting an offer of credit from the lender based on the first authorization signal.

8. The system as claimed in claim 6 further comprising means for transmitting market standing data from the credit reporting agency or agent entity to the consumer.

9. The system as claimed in claim 6 further comprising means for receiving personal and credit line data from at least one of the consumer and the lender, the database storing the credit line data.

10. The system as claimed in claim 9 further comprising means for receiving payment record data from the lender, the record data representing a record of the consumer payments on a loan received by the consumer from the lender.

11. A computer readable non-transitory storage medium that stores a set of software instructions which, when executed, controls credit information, the set of software instructions comprising software instructions for:
receiving a selection signal from a consumer to at least partially establish a relationship between the consumer and a credit reporting agency or agent entity;
receiving personal data including credit data of the consumer, wherein the personal data includes at least one of bank loan transaction records, utility payment records, credit card payment records, name, address, employer, and the like that relate to a credit rating of the consumer;
storing the personal data in a database of the credit reporting agency or agent entity;
receiving a data request signal from the consumer which represents a request by the consumer to access the personal data from the database;
transmitting at least a portion of the accessed personal data from the credit reporting agency or agent entity to the consumer based on the data request signal;
receiving additional personal data from the consumer which represents proposed additions or deletions to the accessed personal data;
receiving a data forward request signal from the consumer which represents a request by the consumer to forward the additional personal data to a preferred credit reporting agency or any credit reporting agency;
transmitting the additional personal data based on the data forward request signal;
receiving a first authorization signal from the consumer which represents authorization for the credit reporting agency or agent entity to request an offer of credit from a lender; and
receiving a second authorization signal from the consumer which represents authorization to the credit reporting agency or agent entity to include the personal data of the consumer in the request of the credit reporting agency or agent entity.

12. The storage medium as claimed in claim 11 wherein the set of software instructions comprise software instructions for transmitting an offer request signal from the credit reporting agency to the lender requesting an offer of credit from the lender based on the first authorization signal.

13. The storage medium as claimed in claim 11 wherein the set of software instructions comprise software instructions for transmitting market standing data from the credit reporting agency or agent entity to the consumer.

14. The storage medium as claimed in claim 11 wherein the set of software instructions comprise software instructions for receiving personal and credit line data from at least one of the consumer and the lender and for storing the credit line data in the database.

15. The storage medium as claimed in claim 14 wherein the set of software instructions comprise software instructions for receiving payment record data from the lender, the record data representing a record of the consumer payments on a loan received by the consumer from the lender.
